(19) United States
(12) Patent Application Publication
(10) Pub. No.: US 2017/0278490 A1
(43) Pub. Date: Sep. 28, 2017

(54) PEDAL APPARATUS FOR PERCUSSION INSTRUMENT

(71) Applicant: YAMAHA CORPORATION, Hamamatsu-shi (JP)

(72) Inventors: Fumihiro SHIGENAGA, Hamamatsu-shi (JP); Hirochika WATANABE, Hamamatsu-shi (JP); Tomohiro FUJITA, Hamamatsu-shi (JP); Makoto SETO, Hamamatsu-shi (JP)

(21) Appl. No.: 15/451,516

(22) Filed: Mar. 7, 2017

(30) Foreign Application Priority Data
Mar. 24, 2016 (JP) 2016-060919

(51) Int. Cl. G10D 13/00

(52) U.S. Cl. CPC G10D 13/006

(57) ABSTRACT

Pivot shaft support members, formed as component parts separate from support posts of a frame of a pedal apparatus, are mounted on respective upper ends of the support posts, and the pivot shaft support members pivotably support the opposite ends of a pivot shaft for a beater rod. A heel section is provided on a rear end portion of an under plate of the pedal apparatus, and a pair of left and right hinge support members, formed as component parts separate from the heel section, are mounted to the heel section. The hinge support members pivotably support the opposite ends of a pivot shaft of a hinge section of a foot board. Because the pivot shaft support members and the hinge support members are separate component parts from the frame, mounted positions of these support members can be adjusted finely during mounting, to the frame, of the support members.

### BACKGROUND

The present invention relates generally to a pedal apparatus for use in a performance of a percussion instrument, such as a bass drum of a drum set, and more particularly to an improvement in a structure for bearing or supporting a pivot shaft.

FIG. 7A is a side view of a conventionally-known pedal apparatus 100 for a percussion instrument, and FIG. 7B is a front view of the pedal apparatus 100 of FIG. 7A taken in a direction of arrow E of FIG. 7A. As shown FIGS. 7A and 7B, a frame 110 of the pedal apparatus 100 includes a pair of left and right support posts 112 provided on and extending upward from an under plate 111, and support sections 113 provided at the respective upper ends of the left and right support posts 112 pivotably bear or support a pivot shaft 102 via not-shown bearings. A rocker member 103 is fixed to the pivot shaft 102, and a rod 105 having a beater 107 at its distal end is mounted to the rocker member 103. A transmission mechanism 104, which comprises for example a chain member, is connected at its one end to the front end of a foot board 106 and connected at the other end to the rocker member 103. The pivot shaft 102 pivots via the transmission mechanism 104 in response to a user depressing the board 106, and the beater 107 strikes a bass drum (not shown) in response to the pivoting of the pivot shaft 102. The construction of such a pedal apparatus is disclosed, for example, in Japanese Patent No. 2738318.

In the frame 110 of the aforementioned conventionally-known pedal apparatus 100, the support posts 112 and the support sections 113 are formed integrally with each other. Thus, with the pivot shaft 102 mounted to the support sections 113, the pivot shaft 102 may rattle or wobble due to distortion, deformation, etc. caused during the integral formation of the support posts 112 and the support sections 113. However, with the conventionally-known, integrally-formed frame 110, where positions, relative to the frame 110, of the support sections 113 supporting the opposite end portions of the pivot shaft 102 and the bearings are fixed, there can be provided no means to adjust a relative mounted position of the pivot shaft 102 to the frame 110 (support sections 113), and thus, it is not possible to correct the unwanted wobbling of the pivot shaft 102.

Further, in the case where the support posts 112 and the support sections 113 are formed integrally with each other as noted above, the respective shaft bearing axes of the left and right support sections 113 may be undesirably displaced with each other with respect to the axis of the pivot shaft 102 or may even curve or bend due to the distortion, deformation, etc. caused during the integral formation. Because the left and right support sections 113 are considerably spaced from each other, it is difficult to correct the displacement of the shaft bearing axes of the left and right support sections 113 by post-processing following the formation of the frame 110.

Furthermore, the foot board 106 is pivotably mounted at the rear end to a heel section 114 via a hinge section 108. Left and right support sections 115 supporting a pivot shaft 108a of the hinge section 108 are integrally formed with the heel section 114. Thus, with the structure for supporting the hinge section 108 at the rear end of the foot board 106 too, there would be encountered the problems that: a relative mounted position of the hinge section 108 to the heel section 114 cannot be adjusted; the respective shaft bearing axes of the left and right support sections 115 may be undesirably disaligned or displaced with each other with respect to the axis of the pivot shaft 108a; and it is difficult to correct the displacement of the shaft bearing axes of the left and right support sections 115 by post-processing.

Further, U.S. Pat. No. 6,894,210 and U.S. Pat. No. 9,236,038 corresponding to Japanese patent application laid-open No. 2016-095379 also disclose prior art of a pedal apparatus for a percussion instrument.

### SUMMARY OF THE INVENTION

In view of the foregoing prior art problems, it is an object of the present invention to provide an improved pedal apparatus for a percussion instrument which allows one or more pivot shafts, provided in the pedal apparatus, to be appropriately assembled to a frame with a high accuracy.

In order to accomplish the above-mentioned object, the present invention provides an improved pedal apparatus for a percussion instrument, which comprises: a frame; a foot board; a rod pivotable to move a beater; a pivot shaft provided in a motion link mechanism that pivots the rod in response to pivoting of the foot board; a support member formed as a component part separate from the frame and constructed to pivotably support the pivot shaft; and a connection section provided in corresponding relation to the support member and constructed to connect the corresponding support member to the frame.

In the pedal apparatus for a percussion instrument according to the present invention, the support member that pivotably supports the pivot shaft is formed as a separate component part from the frame, and this support member is connected to the frame via the connection section. Because the support member is a separate component part from the frame, a mounted position of the support member relative to the frame can be adjusted at the time of mounting, to the frame, of the support member. By such mounted position adjustment, it is possible to, for example, duly position the respective shaft bearing axes of a pair of left and right support members in alignment with each other with respect the axis of the pivot shaft. Thus, the pivot shaft can be appropriately assembled to the frame with a high accuracy as compared to the conventionally-known technique where the frame and the support members are formed integrally with each other.

In a case where a plurality of pivot shafts are provided in the motion link mechanism that pivots the rod in response to pivoting of the foot board, a combined structure the support member and the corresponding connection section may be applied in relation to at least one of the pivot shafts. Alternatively, such a combined structure the support member and the corresponding connection section may be applied individually to each of the pivot shafts in accordance with the basic principles of the present invention.

### BRIEF DESCRIPTION OF THE DRAWINGS

Certain preferred embodiments of the present invention will hereinafter be described in detail, by way of example only, with reference to the accompanying drawings, in which:

FIG. 1 is a side view showing an example construction of a pedal apparatus for a percussion instrument in accordance with an embodiment of the present invention;

FIG. 2 is a front view of the pedal apparatus of FIG. 1;

FIG. 3 is a top plan view showing a rear end section the pedal apparatus;

FIG. 4A is a perspective view of the pedal apparatus taken in a direction of arrow A of FIG. 1, which particularly shows the pedal apparatus with a transmission mechanism etc. removed for clarity, FIG. 4B is a fragmentary perspective view showing one of pivot shaft support members in enlarged scale, FIG. 4C is a perspective view showing a frame (support posts) with the pivot shaft support members removed therefrom for clarity, and FIG. 4D shows a state where a pivot shaft is assembled or mounted to the support posts shown in FIG. 4A;

FIG. 5 is a front view showing a modified embodiment of the pivot shaft support member where screw holes are each a laterally elongated hole;

FIG. 6A is a perspective view showing a rear end section of the pedal apparatus taken in a direction of arrow B of FIG. 1 with the transmission mechanism etc. removed for clarity, FIG. 6B is a fragmentary perspective view showing in an enlarged scale one of hinge support members, FIG. 6C is a bottom end view of the hinge support member, and FIG. 6D is a perspective view showing a heel section of the pedal apparatus with the hinge support members removed for clarity; and

FIG. 7A is a side view of a conventionally-known pedal apparatus for a percussion instrument, and FIG. 7B is a front view of the pedal apparatus taken in a direction of arrow E of FIG. 7A.

### DETAILED DESCRIPTION

Now, with reference to the accompanying drawings, a detailed description will be given about an embodiment of a pedal apparatus for a percussion instrument of the present invention. The pedal apparatus for a percussion instrument (hereinafter also referred to simply as “pedal apparatus”) is used, for example, in a performance of a percussion instrument, such as a bass drum of a drum set.

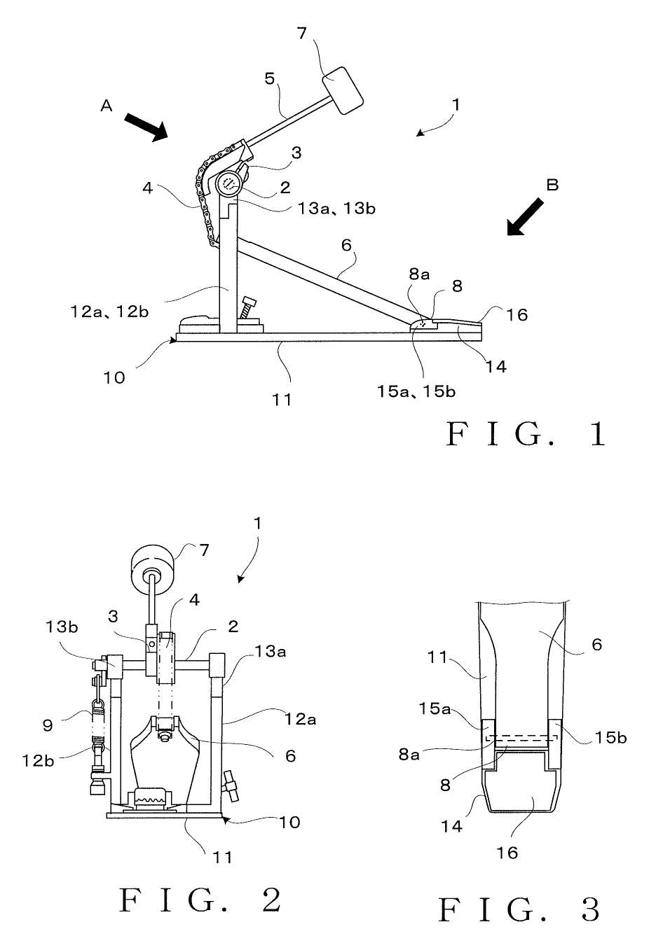

FIG. 1 is a side view showing an example construction of the pedal apparatus 1, and FIG. 2 is a front view of the pedal apparatus 10 taken in a direction of arrow A of FIG. 1. In the following description, terms “forward”. “rearward”, “front”, “rear”, “upward”, “downward”, “up”, “down”, etc. are used to refer to directions as viewed when the pedal apparatus 10 is placed on a horizontal floor surface as shown in FIG. 1; for example, “leftward” in FIG. 1 corresponds to a “forward” direction of the pedal apparatus 10, and “upward” in FIG. 1 corresponds to an “upward” direction of the pedal apparatus 10.

As shown in FIGS. 1 and 2, the pedal apparatus 10 includes a frame 10 installed on the floor surface. The frame 10 includes an under plate 11, and a pair of left and right support posts 12a and 12b provided on and projecting upward from front end portions of the support posts 12a and 12b. Pivot shaft support members 13a and 13b that are formed as component parts separate from the support posts 12a and 12b and that pivotably support the opposite ends of a pivot shaft 2 are mounted to the respective upper ends of the support posts 12a and 12b. With the pivot shaft support members 13a and 13b mounted to the upper ends of the support posts 12a and 12b like this, the pivot shaft 2 is pivotably mounted to the support posts 12a and 12b. Namely, in this case, the support posts 12a and 12b are provided in corresponding relation to the pivot shaft support members 13a and 13b and function as connection sections constructed to connect the corresponding support members 13a and 13b to the frame 10.

A rocker member 3 is fixed to a substantial axial middle portion of the pivot shaft 2, and a beater 7 is mounted to the distal end of a rod 5 that is in turn mounted to the rocker member 3. The rocker member 3, the rod 5 and the beater 7 together constitute a striking mechanism of the pedal apparatus 1. A transmission mechanism 4 that comprises for example a chain member is connected at it upper end to the rocker member 3, and a foot board 6 is connected to the lower end of the transmission mechanism 4.

FIG. 3 is a fragmentary top plan view showing a rear end section of the pedal apparatus 1 with illustration of a front end section of the pedal apparatus 1 omitted. As shown in FIGS. 1 and 3, the foot board 6 includes a hinge section 8 provided at its rear end. A heel section 14 is provided on a rear end portion of the under plate 11. To the heel section 14 are mounted a pair of left and right hinge support members 15a and 15b that are formed as component parts separate from the heel section 14 and that support the opposite ends of a pivot shaft 8a of the hinge section 8. With the hinge support members 15a and 15b mounted to the heel section 14, the pivot shaft 8a of the hinge section 8 is pivotably mounted to the heel section 14 of the frame 10. The upper surface of the heel section 14 is covered with a cover member 16 formed, for example, of rubber. Namely, in this case, the heel section 14 is provided in corresponding relation to the hinge support members 15a and 15b and functions as a connection section constructed to connect the hinge support members 15a and 15b to the frame 10.

As the user depresses the foot board 6, the foot board 6 pivots about the hinge section 8 downward from the position shown in FIG. 1. In response to such pivoting of the foot board 6, the transmission mechanism 4 moves downward, in response to which the pivot shaft 2 pivots forward about the pivot shaft support members 13a and 13b. Namely, rotational force produced by the user's depression of the foot board 6 is transmitted via the transmission mechanism 4 to the pivot shaft 2, and then, in response to the pivoting of the pivot shaft 2, the beater 7 angularly moves to strike the drumhead (not shown) of the bass drum. Then, as the user releases the foot board 2 from the depressed state, the foot board 6 returns to the position shown in FIG. 1 by upward biasing force of a return spring 9 (FIG. 2) connected to one end of the pivot shaft 2. In the pedal apparatus constructed in the aforementioned manner, a mechanism including the pivot shaft 8a of the hinge section 8, the transmission mechanism 4, the rocker member 3, the rod 5, the pivot shaft 2, etc. functions as a motion link mechanism for pivoting the rod 5 in response to the pivoting of the foot board 6.

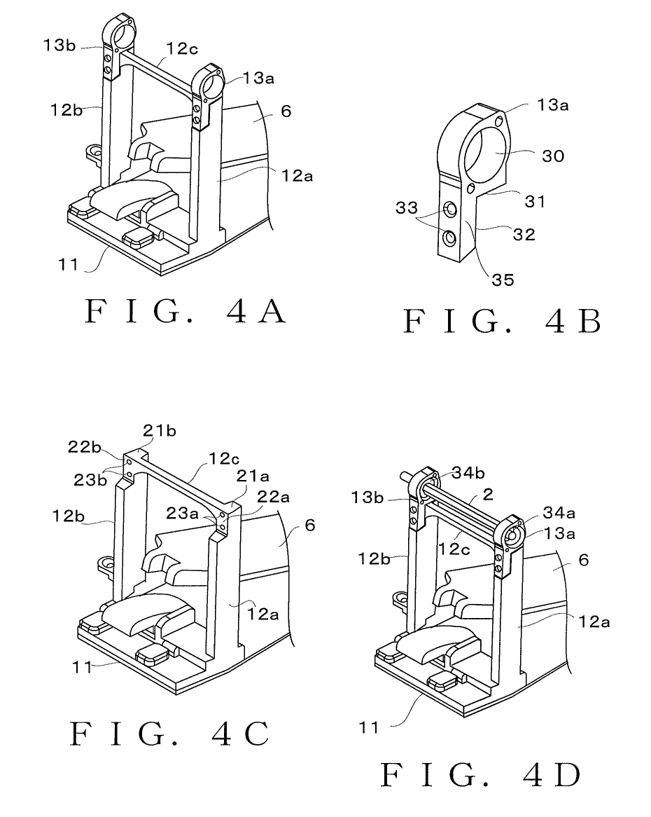

Next, with reference to FIGS. 4A to 4D, a description will be given about an example detailed construction of the pivot shaft support members 13a and 13b. FIG. 4A is a perspective view of the pedal apparatus 1 taken in a direction of arrow A of FIG. 1, which particularly shows the pedal apparatus 1 with the pivot shaft 2, the transmission mechanism 4, etc. removed and with illustration of the rear end section of the pedal apparatus 1 omitted for clarity. FIG. 4B is a fragmentary perspective view showing one of the pivot shaft support members 13a in enlarged scale, and FIG. 4C is a perspective view showing a state where the pivot shaft support members 13a and 13b are removed from the pedal apparatus 1 shown in FIG. 4A.

As shown in FIG. 4B, the pivot shaft support member 13a has a through-hole 30 formed for insertion therein (or therethrough) of an end portion of the pivot shaft 2. A bearing 34a is incorporated in the through-hole 30 as shown in FIG. 4D. The pivot shaft support member 13a also has, on its lower region, two, i.e. first and second, mounting surfaces 31 and 32 as a mounting section to be mounted to the support post 12a. The first mounting surface 31 is formed to extend substantially parallel to the upper surface of the support post 12a, or in other words, substantially perpendicularly to the length of the support post 12a. The second mounting surface 32 is formed to extend substantially perpendicularly to the first mounting surface 31; more specifically, the second mounting surface 32 is one side surface of a leg portion 35 formed to extend downward from the first mounting surface 31. Screw holes 33 are formed in another side surface of the leg portion 35 (i.e., the surface of the leg portion 35 opposite from the second mounting surface 32) for passage therethrough of screws for fixing the pivot shaft support member 13a to the support post 12a.

The other pivot shaft support member 13b has a through-hole 30 having a bearing 34b (see FIG. 4D), two, or, first and second mounting surfaces 31 and 32 as a mounting section to be mounted to the support post 12b and a screw hole 33 which are similar to those of the pivot shaft support member 13a shown in FIG. 4B, although not particularly depicted with reference numerals in FIGS. 4A to 4D.

As shown in FIG. 4C, each of the support posts 12a or 12b has a first abutting surface 21a or 21b formed at its upper end to abut against the first mounting surface 31 of the corresponding pivot shaft support member 13a or 13b, and a second abutting surface 22a or 22b extending downward from the first abutting surface 21a to abut against the second mounting surface 32 of the corresponding pivot shaft support member 13a or 13b. Each of the second abutting surfaces 22a and 22b has screw holes 23a and 23b corresponding to the screw holes 33 of the corresponding pivot shaft support member 13a or 13b. A subframe 12c is formed integrally with the support posts 12a and 12b and extends between the upper ends of the support posts 12a and 12b. With such a subframe 12c provided between the support posts 12a and 12b in parallel to the pivot shaft 2, the frame 10 can have an enhanced structural stability.

The left and right support posts 12a and 12b are formed in such a manner that flatness of the first abutting surfaces 21a and 21b and flatness of the second abutting surfaces 22a and 22b can be made equal between the left and right support posts 12a and 12b through post-processing. Because such processing for making the flatness equal between the left and right support posts 12a and 12b is performed on the flat surfaces, it can be performed with a high accuracy and precision. In this way, it is possible to duly position the respective shaft bearing axes of the left and right support members 13a and 13b in alignment with each other with respect the axis of the pivot shaft 2. Thus, the pivot shaft 2 can be appropriately assembled to the frame 10 with a high accuracy.

The following describe an example operational sequence for mounting the pivot shaft support members 13a and 13b to the corresponding support posts 12a and 12b. First, the pivot shaft support members 13a and 13b are mounted to the opposite ends of the pivot shaft 2 via the bearings 34a and 34b, and then, the two mounting surfaces 31 and 32 of the pivot shaft support members 13a and 13b are abutted against the abutting surfaces 21a and 22a and 22a and 22b, respectively, of the support posts 12a and 12b. Then, the pivot shaft support members 13a and 13b are fastened or fixed to the corresponding support posts 12a and 12b by the screws passed through the screw holes 33 into the screw holes 23a and 23b. FIG. 4D shows a state where the pivot shaft 2 is assembled or mounted to the support posts 12a and 12b shown in FIG. 4A. Note that any other suitable mounting operational sequence than the aforementioned may be employed for mounting the pivot shaft support members 13a and 13b to the support posts 12a and 12b.

Because the pivot shaft support members 13a and 13b are constructed in such a manner that the two mounting surfaces 31 and 32 abut against the support posts 12a and 12b as the pivot shaft support members 13a and 13b are mounted to the support posts 12a and 12b, they can be duly positioned at predetermined positions defined by the two mounting surfaces 31 and 32. Namely, in the instant embodiment, a positioning mechanism for each of the pivot shaft support members 13a and 13b comprises a mounting section constructed in such a manner that the pivot shaft support member 13a or 13b abuts at two or more surfaces (31 and 32) against the corresponding support post 12a or 12b.

Further, when the pivot shaft support members 13a and 13b are to be mounted to the support posts 12a and 12b, mounted positions of the pivot shaft support members 13a and 13b relative to the support posts 12a and 12b can be adjusted finely by adjusting the respective screwed-in amounts of the screws in the screw holes 33, 23 and 23b, fixing the pivot shaft support members 13a and 13b by pressing them laterally from the left and right sides, or the like. By such mounted position adjustment of the pivot shaft support members 13a and 13b, it is possible to prevent unwanted wobbling of the pivot shaft 2 assembled to the frame 10.

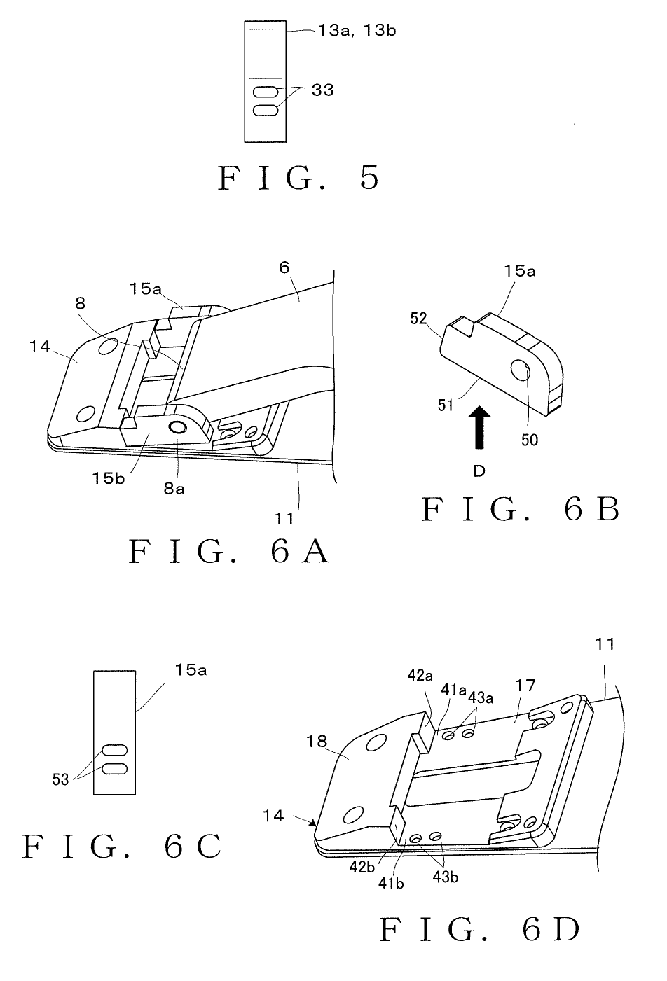

FIG. 5 shows a modified embodiment where the screw holes 33 in each of the pivot shaft support members 13a and 13b are each a laterally elongated hole that is elongated in shape in the left-right direction. In this case, the screw holes 33 function as a mounted position adjustment mechanism for adjusting the mounted positions of the pivot shaft support members 13a and 13b relative to the support posts 12a and 12b. With such a mounted position adjustment mechanism, the user can adjust the mounted positions of the pivot shaft support members 13a and 13b in the left-right direction relative to the support posts 12a and 12b within a range permitted by the screw holes 33. Note that the screw holes 33 may be formed in any other shape, such as a shape elongated vertically or in the up-down direction, or a shape that permits positional adjustment of the pivot shaft support members 13a and 13b in both the left-right direction and the up-down direction.

According to the above-described embodiments of the pedal apparatus 1, where the pivot shaft support members 13a and 13b are formed as component parts separate from the support posts 12a and 12b, the pivot shaft 2 can be appropriately assembled to the support posts 12a and 12b of the frame 10 with a high accuracy. In the above-described embodiments, the basic principles of the present invention are applied in relation to the pivot shaft 2 of the rod 5 provided for pivoting the beater 7, and the pivot shaft 2 is a pivot shaft (first pivot shaft) provided in the motion link mechanism for pivoting the rod 5 in response to pivoting motion of the foot board 6. Further, the pivot shaft support members 13a and 13b constitute a support member (first support member) that pivotably supports the first pivot shaft 2, and the support posts 12a and 12b constitute a connection section (first connection section) that is constructed to connect the first support member to the frame 10.

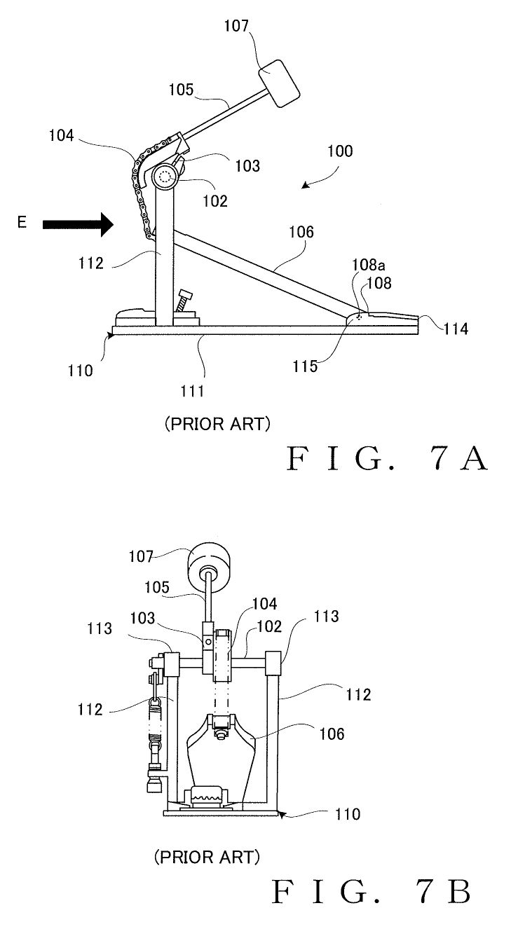

Next, with reference to FIG. 6, a description will be given about an example where the basic principles of the present invention are applied in relation to the pivot shaft 8a for the foot board 6. FIG. 6A is a perspective view showing the rear end section of the pedal apparatus 1 in a direction of arrow B of FIG. 1 with the cover member 16 removed and with illustration of a front end section of the apparatus 1 omitted for clarity. As shown in FIG. 6A, the left and right hinge support members 15a and 15b are disposed on left and right side edge portions of the heel section 14.

FIG. 6B is a perspective view showing in an enlarged scale one of the left and right hinge support members 15a. The hinge support member 15a has a through-hole 50 formed therein to support the pivot shaft 8a of (for) the foot board 6, and a not-shown bearing is incorporated in the through-hole 50. The hinge support member 15a has two, i.e. first and second, mounting surfaces 51 and 52 as a mounting section to be mounted to the heel section 14. The first mounting surface 51 corresponds to the bottom surface of the hinge support member 15a, and the second mounting surface 52 corresponds to a rear end surface of the hinge support member 15a. The first and second hinge support members 51 and 52 are formed at right angles to each other. FIG. 6C is a bottom end view of the hinge support member 15a. The hinge support member 15a has screw holes 53 formed for insertion therein of screws for fastening the hinge support member 15a to the heel section 14. The screw holes 53 are each a laterally elongated hole, elongated in the left-right direction, so that a mounted position of the hinge support member 15a relative to the heel section 14 is adjustable in the left-right section within a range permitted by the screw holes 53.

Although not particularly shown, the other hinge support member 15b has a through-hole 50, two mounting surfaces 51 and 52 and a screw hole 14 which are similar to those of the one hinge support member 15a shown in FIG. 6B, although not particularly depicted with reference numerals.

FIG. 6D shows the rear end section of the pedal apparatus 1 with the hinge support members 15a and 15b removed for clarity. As shown in FIG. 6D, the heel section 14 includes a base portion 17, and a heel body 18 formed integrally with the base body 18 and projecting upward from the base portion 17. The base portion 17 has, on its left and right side edge portions, first abutting surfaces 41a and 41b that abut against the first mounting surfaces 51 of the left and right hinge support members 15a and 15b. The heel body 18 has, on its left and right front end surfaces, second abutting surfaces 42a and 42b that abut against the second mounting surfaces 52 of the left and right hinge support members 15a and 15b. The first abutting surfaces 41a and 41b each have screw holes 43a and 43b corresponding to the screw holes 53 of the corresponding hinge support member 15a or 15b.

The heel section 14 too is formed in such a manner that flatness of the first abutting surfaces 41a and 41b and flatness of the second abutting surfaces 42a and 42b can be made equal through post-processing. In this way, the respective shaft bearing axes of the left and right hinge support member 15a and 15b mounted to the heel section 14 can be duly positioned in alignment with each other with respect to the axis of the pivot shaft 8a of the hinge section 8, so that the pivot shaft 8a of the hinge section 8 can be appropriately supported by the left and right hinge support members 15a and 15b.

The following describe an example operational sequence for mounting the hinge support members 15a and 15b to the heel section 14. First, the hinge support members 15a and 15b are mounted to the opposite ends of the pivot shaft 8a of the hinge section 8, and then, the two mounting surfaces 51 and 52 of the hinge support members 15a and 15b are abutted against the abutting surfaces 41a, 42a and 41b, 42b, respectively, of the heel section 14. Then, the hinge support members 15a and 15b are fastened or fixed to the heel section 14 by means of screws passed through the screw holes 43a and 43b into the screw holes 53. Note that any other suitable hinge-support-member mounting operational sequence than the aforementioned may be employed.

With the above-described construction where the two mounting surfaces 51 and 52 of each of the hinge support members 15a and 15b abut against the abutting surfaces 41a, 42a and 41b, 42b, respectively, of the heel section 14 during mounting, to the heel section 14, of the hinge support members 15a and 15b, the hinge support members 15a and 15b can be duly positioned at predetermined positions defined by the two mounting surfaces 51 and 52. Namely, in the instant embodiment, each of the hinge support members 15a and 15b has, as a positioning mechanism, a mounting section formed in such a manner that the hinge support member abuts against the heel section 14 at two or more surfaces (51 and 52).

Further, when the hinge support members 15a and 15b are to be mounted to the heel section 14, mounted positions of the hinge support members 15a and 15b relative to the heel section 14 can be adjusted finely by adjusting screwed-in amounts of the screws in the screw holes 53, 43a and 43b, fixing the hinge support members 15a and 15b by pressing them laterally from the left and right sides, or the like. By such fine mounted position adjustment of the hinge support members 15a and 15b, it is possible to prevent unwanted wobbling of the pivot shaft 8a of the hinge section 8 assembled to the heel section 14.

Furthermore, the screw holes 53 formed as laterally elongated holes in the hinge support members 15a and 15b function as a mounted position adjustment mechanism for the support members 15a and 15b. With such a mounted position adjustment mechanism, the user can adjust the mounted positions of the hinge support members 15a and 15b in the left-right direction within a range permitted by the screw holes 53. Note that the screw holes 53 may be formed in any other shape than the aforementioned, such as a shape elongated in the front-rear direction, or a shape that permits positional adjustment of the hinge support members 15a and 15b in both the left-right direction and the front-rear direction.

In the instant embodiment of the pedal apparatus 1, where the hinge support members 15a and 15b are formed as component parts separate from the heel section 14 as noted above, the pivot shaft 8a of the hinge section 8 can be appropriately assembled to the heel section 14 with a high accuracy. In the above-described embodiment, the basic principles of the present invention are applied in relation to the pivot shaft 8a of the foot board 6, and the pivot shaft 8a is a pivot shaft (second pivot shaft) provided in the aforementioned motion link mechanism for pivoting the rod 5 in response to a pivoting motion of the foot board 6. Further, the hinge support members 15a and 15b constitute a support member (second support member) that pivotably supports the second pivot shaft 8a, and a connection structure (abutting surfaces) of the heel section 14 for connecting the hinge support members 15a and 15b to the heel section 14 constitutes a connection section (second connection section) that is constructed to connect the second support member to the frame 10 via the heel section 14 of the foot board 6.

It should be appreciated that the present invention is not limited to the above-described embodiments and may be modified variously within the scope of the technical idea disclosed in the claims, specification and drawings.

For example, as another example of the mounted position adjustment mechanism provided in each of the pivot shaft support members 13a and 13b, a position adjustment member may be provided between each of the pivot shaft support members 13a and 13b and the corresponding support post 12a or 12b. Each of such position adjustment members may be a resilient member, such as a plain washer or a spring washer. The positions, in the up-down direction, of the pivot shaft support members 13a and 13b can be adjusted via the position adjustment members provided between the first mounting surfaces 31 and the first abutting surfaces 21a and 21b, and the positions, in the front-rear direction, of the pivot shaft support members 13a and 13b can be adjusted via the position adjustment members provided between the second mounting surfaces 32 and the second abutting surfaces 22a and 22b. Further, as another example of the mounted position adjustment mechanism provided in each of the hinge support members 15a and 15b, position adjustment members similar to the aforementioned position adjustment members of the pivot shaft support members 13a and 13 may be provided between the hinge support members 15a and 15b and the heel section 14.

Furthermore, the positioning mechanism of each of the pivot shaft support members 13a and 13b is not limited to the aforementioned construction where each of the pivot shaft support members 13a and 13b abuts against the support post 12a or 12b at two or more mounting surfaces 31 and 32, and it may be of any other suitable construction. For example, positioning guide holes or grooves may be provided the pivot shaft support members 13a and 13b or in the support posts 12a and 12b. The positioning mechanism of each of the hinge support members 15a and 15b too is not limited to the construction where each of the hinge support members 15a and 15b abuts against the heel section 14 at two or more mounting surfaces 51 and 52, and it may be of any other suitable construction. For example, positioning guide holes or grooves may be provided in the hinge support members 15a and 15b or in the heel section 14. Whereas, in the above-described embodiments, combined structures the support members 13a, 13b and 15a, 15b (first and second support members) and the corresponding support posts 12a, 12b and hinge support members 15a and 15b (first and second connection sections) are provided in relation to both the pivot shaft 2 of the rod 5 (i.e., the first pivot shaft) and the pivot shaft 8a of the foot board 6 (i.e., the second pivot shaft) in accordance with the basic principles of the present invention, the present invention is not so limited, and the combined structure of the support member and the connection section according to the present invention may be provided in relation to only one of the pivot shafts 2 and 8a (i.e., the first pivot shaft or the second pivot shaft).

This application is based on, and claims priority to, JP PA 2016-060919 filed on 24 Mar. 2016. The disclosure of the priority application, in its entirety, including the drawings, claims, and the specification thereof, are incorporated herein by reference.

What is claimed is:

1. A pedal apparatus for a percussion instrument comprising:
a frame;
a foot board;
a rod pivotable to move a beater;
a pivot shaft provided in a motion link mechanism that pivots the rod in response to pivoting of the foot board;
a support member formed as a component part separate from the frame and constructed to pivotably support the pivot shaft; and
a connection section provided in corresponding relation to the support member and constructed to connect the corresponding support member to the frame.

2. The pedal apparatus for a percussion instrument as claimed in claim 1, wherein the support member includes a positioning mechanism that defines a mounted position of the support member relative to the connection section.

3. The pedal apparatus for a percussion instrument as claimed in claim 2, wherein the positioning mechanism comprises a mounting section having a plurality of abutting surfaces engageable with the connection section.

4. The pedal apparatus for a percussion instrument as claimed in claim 1, wherein the support member includes a position adjustment mechanism that adjusts a mounted position of the support member relative to the connection section.

5. The pedal apparatus for a percussion instrument as claimed in claim 4, wherein the position adjustment mechanism comprises a position adjustment member disposed between the support member and the connection mechanism.

6. The pedal apparatus for a percussion instrument as claimed in claim 1, wherein the pivot shaft is a pivot shaft for the rod, and
the connection section is constructed to connect, to the frame, the support member that pivotably supports the pivot shaft for the rod.

7. The pedal apparatus for a percussion instrument as claimed in claim 6, wherein the support member comprises a pair of support members each configured to pivotably support the pivot shaft for the rod so that the pivot shaft for the rod extends between the pair of support members,
the connection section comprises a pair of support posts each provided on the frame, each one of the pair of support members being mounted to corresponding one of the pair of support posts,
a subframe that is formed integrally with the pair of support posts is provided so as to extend between the pair of support posts.

8. The pedal apparatus for a percussion instrument as claimed in claim 1, wherein the pivot shaft is a pivot shaft for the foot board, and
the connection section is constructed to connect, to the frame via a heel section of the foot board, the support member that pivotably supports the pivot shaft for the foot board.

9. The pedal apparatus for a percussion instrument as claimed in claim 1, wherein the pivot shaft includes a first pivot shaft for the rod, and a second pivot shaft for the foot board,
the support member includes a first support member that pivotably supports the first pivot shaft, and a second support member that pivotably supports the second pivot shaft, and
the connection section includes a first connection section constructed to connect the first support member to the frame, and a second connection section constructed to connect the second support member to the frame via a heel section of the frame.
